(19) United States
(12) Patent Application Publication
(10) Pub. No.: US 2020/0173776 A1
(43) Pub. Date: Jun. 4, 2020

(54) INCLINOMETER

(71) Applicant: Enteq Upstream PLC, Amersham (GB)

(72) Inventors: Derek Hayes, Amersham (GB); Philip Head, Amersham (GB)

(21) Appl. No.: 16/693,488

(22) Filed: Nov. 25, 2019

(30) Foreign Application Priority Data
Dec. 3, 2018 (GB) 1819709.5

(51) Int. Cl. G01C 9/06; G01P 15/08; B23B 49/00

(52) U.S. Cl. CPC G01C 9/06; B23B 49/00; G01P 15/08

(57) ABSTRACT

An inclinometer subassembly for determining the inclination of a single measurement axis, the subassembly comprising: a first pair of accelerometers comprising a first accelerometer and a second accelerometer; and a second pair of accelerometers comprising a third accelerometer and a fourth accelerometer; wherein each accelerometer comprises at least one sensing axis for sensing acceleration due to gravity relative to its at least one sensing axis; wherein the first and second accelerometers of the first pair are arranged such that the at least one sensing axis of each of the first and second accelerometers is orientated in the same direction as the single measurement axis, wherein the second accelerometer is arranged in an orientation in which it has been rotated about its at least one sensing axis by 180 degrees relative to the first accelerometer; wherein the third and fourth accelerometers of the second pair are arranged such that the at least one sensing axis of each of the third and fourth accelerometers is orientated in the opposite direction to the at least one sensing axis of each of the first and second accelerometers, wherein the fourth accelerometer is arranged in an orientation in which it has been rotated about its at least one sensing axis by 180 degrees relative to the third accelerometer; wherein each accelerometer comprises an output for providing an output signal from its at least one sensing axis to control circuitry such that an inclination of the subassembly indicative of the inclination of the single measurement axis can be determined based on a combination of the output signals from the first, second, third and fourth accelerometers.

The present invention relates to an inclinometer for determining inclination of a measurement axis. In particular, the invention relates to inclinometer subassemblies and assemblies comprising accelerometers for determining inclination of one or more measurement axes. Further aspects of the invention relate to a drilling tool comprising an inclinometer assembly and also to a method for determining inclination of one or more measurement axes. It will be appreciated that the inclinometer subassemblies and assemblies of the present invention may be used in applications other than drilling operations.

An inclinometer is a device for measuring angles of inclination or tilt of an object relative to a reference direction, for example, the direction of gravity. Inclinometers which use accelerometers to determine inclination are known and are used in a variety of applications such as in the guidance systems of space satellites, in guided medical devices, in mobile computing devices and electronic game controllers.

Another application for an inclinometer is in directional drilling, which uses a steerable drill bit to drill boreholes in a desired direction. In the oil and gas industry this can be used to access more of the natural resources present in a mineral formation than would otherwise be achievable using conventional vertical drilling. For example, the drill bit can be steered into a horizontal direction to follow a horizontal seam in a mineral formation to liberate natural resources along a length of the horizontal seam.

To accurately guide the drill bit it is important to know its orientation, which can be ascertained by determining the inclination of three orthogonal axes relative to a reference vector. One method of determining inclination is to use an accelerometer. These are electromechanical devices that can sense static forces such as gravity and dynamic forces such as vibrations and movement on one, two or three axes and output an electrical signal indicative of the acceleration on a particular axis. Increasingly, microchip-sized accelerometers based around micro-electro-mechanical systems (MEMS) are being used due to their improving accuracy, small size and robustness.

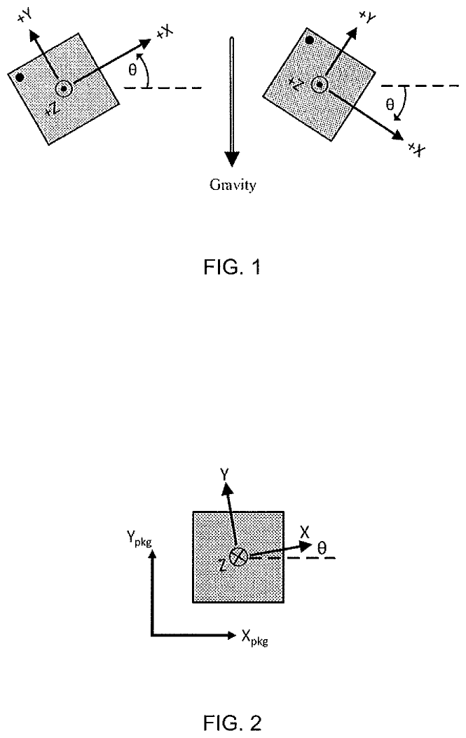

FIG. 1 shows an example of a 3-axis accelerometer of the type which can be used in the present invention. The X- and Y-sensing axes are in the plane of the page and the Z-sensing axis is shown extending out of the page. The accelerometer on the left of FIG. 1 has been rotated anticlockwise through gravity by an angle θ about the Z-axis. Gravity creates a static 1 g (9.8 m/s²) acceleration field. The inclination of a sensing axis of the accelerometer can be determined by projecting the gravity vector on to the sensing axis in question. For example, in FIG. 1, the output X from the X-axis will equal +1 g×sin(θ). The output X will increase as θ increases until it reaches a maximum of +1 g when θ equals 90 degrees above the horizontal. When θ equals zero, i.e. when the X-axis is horizontal, the output X will equal zero also.

The accelerometer on the right of FIG. 1 has been rotated clockwise through gravity also by an angle θ. In this orientation, the output X from the X-axis will equal −1 g x sin(θ). The output X will decrease as θ increases until it reaches a maximum of −1 g when θ equals 90 degrees below the horizontal. Again, when θ equals zero, i.e. when the X-axis is horizontal, the output X will equal zero also.

The sign convention of the output from sensing axes rotated above the horizontal being positive and output from sensing axes rotated below the horizontal being negative will be used in this application to explain the mathematical theory of operation. However, in practice, accelerometers may use a dc reference voltage and the output signals from the accelerometer will be ratiometric to the reference voltage such that a 0 g output is centred on a midpoint of the reference voltage, i.e. a dc offset voltage. Some types of accelerometer produce an analogue output, i.e. a voltage, and other types of accelerometer produce a digital output, i.e. a binary number indicative of the voltage. For example, in an accelerometer producing an analogue output, a 1.8V reference voltage would generate an output of 0.9V at 0 g. Alternative devices may use a different reference voltage range centred on 0V.

The sensitivity of an accelerometer will generally depend on its sensing range. For example, the sensitivity may be 40 mV/g for ±20 g range and 80 mV/g for a ±10 g range. Therefore, for a range of ±20 g and a reference voltage of 1.8V, a +1 g signal will typically produce a 0.94V output voltage and a −1 g signal will typically produce a 0.86V output voltage. In other words, if the output voltage is more than the dc offset voltage, it is indicative of a positive acceleration and if it is less than the dc offset voltage, it is indicative of a negative acceleration. Alternative devices may have different types of output signal e.g. differential outputs for each axis centred on a different reference voltage, or frequency outputs centred on a nominal frequency.

A challenge of using accelerometers in drilling operations is that the output signal from the accelerometer can possess large amounts of noise due to the alternating and high frequency components generated by the high levels of vibration and shock encountered during drilling.

In addition, accelerometers are prone to errors which can affect the accuracy of measurements obtained by the accelerometers. One error exhibited by accelerometers is misalignment error. This occurs when the accelerometer's sensing axis or axes are rotated very slightly from the ideal position due to an error during fabrication. FIG. 2 shows an example of an accelerometer having an alignment error. In FIG. 2, the accelerometer sensing axes X and Y are not aligned with the X_{pkg} and Y_{pkg} axes of the package, i.e. the axes of the outer casing or package of the accelerometer device or chip but are instead arranged at an angle θ to the X_{pkg} and Y_{pkg} axes of the package. Consequently, when the X_{pkg} axis of the accelerometer device is horizontal, the accelerometer sensing axis X has an output indicative of a small positive acceleration. Hence, the accelerometer indicates that it is slightly inclined rather than horizontal due to the misalignment error.

Another error encountered with accelerometers is offset drift due to environmental conditions such as temperature. For a given accelerometer, when the sensing axis is in a 0 g orientation, i.e. when the sensing axis is horizontal, the output from the sensing axis should indicate zero acceleration, for example, either 0 Volts or a known constant dc voltage offset indicative of a 0 g orientation, as discussed above. Ideally, when the device is exposed to differing environmental temperatures, the output should not change. However, in practice there is a tendency for the so-called “offset” to drift with temperature leading to an error when sensing acceleration on a certain axis. This is a particular problem when using accelerometers in drilling applications due the geothermal gradient experienced during drilling, i.e. the temperature of the earth increases as the depth of the drilling operation increases. Furthermore, in multi-axis devices such as a triple-axis accelerometer, it is known for certain axes to drift more due to temperature changes than other axes. For example, the offsets of the X- and Z-axes may drift more at high temperatures than the Y-axis. This can lead to a disparity in readings between axes, particularly when using a single accelerometer.

A similar problem to offset drift encountered by accelerometers is vibration rectification error (VRE), which is the response of an accelerometer to alternating current (ac) vibrations that get rectified to direct current (dc). VRE results in a deviation of the normal offset of the accelerometer. This can be a significant problem when using accelerometers in drilling operations due to the high levels of vibration. The two main factors that cause VRE are: 1) clipping, i.e. when the measured acceleration exceeds the full-scale range of the accelerometer. This results is an asymmetric signal and can be problematic if the signal is applied to filter circuits; and 2) accelerometer non-linearity, i.e. deviation of the accelerometer output from a best fit straight line over the operating range.

Another error exhibited by multi-axis accelerometers is “cross-talk” or “cross-axis sensitivity”. This is a measure of how much output is seen on one axis when acceleration is imposed on a different axis and is normally expressed as a percentage. An ideal accelerometer would have zero cross-talk. However, due to misalignment error, which is a key component of cross-talk, and other causes such as polarisation errors in piezoelectric-based accelerometers, etching inaccuracies, and circuit crosstalk, low values of cross-talk are to be expected. A high-quality accelerometer may have cross-talk values ranging from 3% to 5%. This will adversely affect the accuracy of the accelerometer outputs for any particular sensing axis.

It would be desirable to provide an inclinometer subassembly and assembly for a drilling tool comprising an accelerometer which is less susceptible to the high levels of shock and vibration and the high temperatures encountered during a drilling operation. It would be further desirable to provide an inclinometer subassembly and assembly which is less susceptible to errors.

According to a first aspect of the invention, there is provided an inclinometer subassembly for determining the inclination of a single measurement axis, the subassembly comprising: a first pair of accelerometers comprising a first accelerometer and a second accelerometer; and a second pair of accelerometers comprising a third accelerometer and a fourth accelerometer; wherein each accelerometer comprises at least one sensing axis for sensing acceleration due to gravity relative to its at least one sensing axis; wherein the first and second accelerometers of the first pair are arranged such that the at least one sensing axis of each of the first and second accelerometers is orientated in the same direction as the single measurement axis, wherein the second accelerometer is arranged in an orientation in which it has been rotated about its at least one sensing axis by 180 degrees relative to the first accelerometer; wherein the third and fourth accelerometers of the second pair are arranged such that the at least one sensing axis of each of the third and fourth accelerometers is orientated in the opposite direction to the at least one sensing axis of each of the first and second accelerometers, wherein the fourth accelerometer is arranged in an orientation in which it has been rotated about its at least one sensing axis by 180 degrees relative to the third accelerometer; wherein each accelerometer comprises an output for providing an output signal from its at least one sensing axis to control circuitry such that an inclination of the subassembly indicative of the inclination of the single measurement axis can be determined based on a combination of the output signals from the first, second, third and fourth accelerometers.

As used herein, the term “measurement axis” means an axis of an object such as a drilling tool which the inclinometer subassembly is intended to measure the inclination of.

As used herein, the term “same direction” includes directions which are substantially aligned with, or are arranged substantially parallel to, a reference direction such as the direction of a measurement axis.

As used herein, the term “opposite direction” includes opposing directions which are substantially aligned with, or are arranged substantially parallel to, a reference direction such as the direction of a measurement axis.

In the present invention, the use of four accelerometers per measurement axis, i.e. the first to fourth accelerometers described above, means that the subassembly generates four times the signal compared to a single accelerometer. This significantly improves the signal-to-noise ratio. Indeed, the signal-to-noise ratio is improved by a factor of 14 i.e. by a factor of two. Furthermore, when the signal is processed digitally, the extra signal strength adds two extra bits of resolution for a given sampling time, all other things being equal. A proportion of the noise can also be removed from the output signals from the accelerometers by using analogue or digital filtering techniques.

The use of multiple accelerometers in the arrangement described above means that errors in the signals can be reduced or corrected simply by combining the signals rather than having to use error correction algorithms. Consequently, processing of the signal is reduced and the speed of determining inclination is increased. In particular, by arranging the second and fourth accelerometers in an orientation in which they have been rotated about their at least one sensing axis by 180 degrees relative to the first and third accelerometers respectively, any misalignment or cross-talk errors present in the output signals from the second and fourth accelerometers is given a polarity opposite to that of misalignment or cross-talk errors present in the output signals from the first and third accelerometers. As a result, the signal strength can be increased and errors reduced simply by combining the signals.

In addition, by arranging the at least one sensing axis of each of the third and fourth accelerometers of the second pair such that they are orientated in the opposite direction to the at least one sensing axis of each of the first and second accelerometers, any offset drift error present in the output signals from the third and fourth accelerometers is given a polarity opposite to that of offset drift errors present in the output signals from the first and second accelerometers. As a result, the signal strength can be increased and errors reduced simply by combining the signals.

The subassembly may further comprise control circuitry for receiving the output signal from each of the first, second, third and fourth accelerometers and to combine the signals to determine the inclination of the subassembly.

The accelerometers of each pair of accelerometers may be mounted on the same printed circuit board (PCB). This avoids alignment errors between PCBs and results in improved cancellation of errors when the output signals from each pair of accelerometers are combined.

The accelerometers of each pair of accelerometers may be mounted on opposing sides of the same PCB. This arrangement is a particularly convenient way of achieving an orientation of the second and fourth accelerometers such that they have been rotated about their at least one sensing axis by 180 degrees relative to the first and third accelerometers respectively.

The first and second accelerometers may be mounted on a first PCB and the third and fourth accelerometers may be mounted on a second PCB. Alternatively, all of the first, second, third and fourth accelerometers may be mounted on the same PCB.

The accelerometers may be matched such that the first and second accelerometers have substantially the same misalignment error and the third and fourth accelerometers have substantially the same misalignment error. This results in improved cancellation of errors when the output signals from each pair of accelerometers are combined.

The offset drift of the first accelerometer may be substantially thermally matched to the offset drift of one of the third and fourth accelerometers and the offset drift of the second accelerometer may be substantially thermally matched to the offset drift of the other of the third and fourth accelerometers. This results in improved cancellation of errors when the output signals are combined.

The first accelerometer may be located in the vicinity of one of the third and fourth accelerometers and the second accelerometer may located in the vicinity of the other of the third and fourth accelerometers. This increases the likelihood that the accelerometers will be at substantially the same temperature and therefore subject to the same offset drift which will improve cancellation of errors when the output signals are combined. The dimensions of the subassembly are sufficiently compact such that the respective accelerometers are located in the vicinity of each other.

The accelerometers may have an operating range of at least ±25 g. This has been found to reduce the effects of vibration rectification effort by reducing the likelihood that the accelerometer will be subject to an acceleration outside its operating range.

The at least one sensing axis comprises a primary sensing axis, wherein each accelerometer further comprises two secondary sensing axes, the primary and two secondary sensing axes being arranged in mutually orthogonal directions such that each accelerometer is configured to sense acceleration due to gravity in three orthogonal axes. This means that the most accurate and less error prone axis can be selected to be the primary sensing axis and only the output signals from the primary sensing axis used for the determination of inclination. This helps to improve the accuracy of the inclination determined by the subassembly.

The primary sensing axis comprises the Y sensing axis of the accelerometers and the two secondary axes may comprise the X and Z axes. It has been found that for certain accelerometers the Y sensing axis is more accurate and less prone to offset drift than the X or Z axes. Alternatively, for accelerometers in which either the X- or Z-axis is the more accurate and consistent axis, the primary sensing axis may comprise either the X- or Z-axis.

In arrangements in which the primary sensing axis of the accelerometers comprises the Y-axis, the Y axis of each of the first and second accelerometers may be orientated in the same direction as the single measurement axis. The X axes of the first and second accelerometers may be orientated in opposing directions and the Z axes of the first and second accelerometers are orientated in opposing directions. Furthermore, the Y axis of each of the third and fourth accelerometers may be orientated in the opposite direction to the first and second accelerometers, i.e. in the opposite direction to the direction of the single measurement axis. The X axes of the third and fourth accelerometers may be orientated in opposing directions and the Z axes of the third and fourth accelerometers may be orientated in opposing directions. This configuration means that the most accurate axis, i.e. the Y-axis of each of the accelerometers, is either aligned with or arranged parallel to the measurement axis and any errors due to the X or Z axes are substantially cancelled due to their opposing arrangement.

According to a second aspect of the invention, there is provided an inclinometer assembly for determining the inclination of each of three mutually orthogonal measurement axes, the assembly comprising an inclinometer subassembly as described above for each axis of the assembly; wherein each subassembly is arranged such that the at least one sensing axis of each of its accelerometers is oriented parallel to its respective measurement axis of the assembly.

This arrangement increases the total number of accelerometers used to twelve, i.e. four accelerometers for each axis. Therefore, the benefits of improved signal-to-noise ratio and error reduction described above in respect of the subassembly are also achieved in each subassembly of the inclinometer assembly for each of its measurement axes.

The inclinometer assembly further comprises control circuitry which may be arranged to receive the output signal from each accelerometer of each subassembly and to determine the inclination of each subassembly about its respective measurement axis by combining the output signal from the first, second, third and fourth accelerometers of each subassembly.

The control circuitry may be configured to add together the output signals OS1, OS2 from the first and second accelerometers respectively. The control circuitry may be further configured to add together the output signals OS3, OS4 from the at least one sensing axes of the third and fourth accelerometers respectively. Combining signals in this way helps to reduce misalignment and cross-talk errors. The second and fourth accelerometers are arranged in an orientation in which their at least one sensing axis has been rotated by 180 degrees relative to the first and third accelerometers respectively. Consequently, any errors due to misalignment or cross-talk present in the output signals of the second and fourth accelerometers have an opposite polarity to that of errors due to misalignment or cross-talk present in the output signals of the first and third accelerometers respectively. Therefore, when the output signal OS1 from the first accelerometer is added to the output signal OS2 from the second accelerometer and when the output signal OS3 from the third accelerometer is added to the output signal OS4 from the fourth accelerometer the error signals are reduced or cancelled to significant degree due to their opposing polarities.

The control circuitry may be configured to determine an overall signal OS_{TOT} by subtracting the summation (OS3+OS4) of the output signals OS3 and OS4 from the summation (OS1+OS2) of the output signals OS1 and OS2 in accordance with the equation: OS_{TOT}=(OS1+OS2) −(OS3+OS4). Combining signals in this way means that any offset drift error present in the output signals of the accelerometers is reduced or cancelled to significant degree when the subtraction is performed.

Alternatively, pairs of output signals can be subtracted by the control circuitry prior to adding any signals together. In one option, the control circuitry is configured to subtract the output signal OS3 of the third accelerometer from the output signal OS1 of the first accelerometer and to subtract the output signal OS4 of the fourth accelerometer from the output signal OS2 of the second accelerometer. In another option, the control circuitry is configured to subtract the output signal OS4 of the fourth accelerometer from the output signal OS1 of the first accelerometer and to subtract the output signal OS3 of the third accelerometer from the output signal OS2 of the second accelerometer. Combining signals in this way means that any offset drift error present in the output signals of the accelerometers is reduced or cancelled to significant degree when the respective subtracting is performed.

Since the third and fourth accelerometers are arranged such that their at least one sensing axes are orientated in the opposite direction to the at least one sensing axes of the first and second accelerometers, the output signals OS3 and OS4 from the third and fourth accelerometers respectively have an opposite polarity to the output signals OS1 and OS2 of the first and second accelerometers. Hence, the subtraction of the output signals OS3 and OS4 from the output signals OS1 and OS2 increases the signal strength to four times the signal strength of a single accelerometer whilst also reducing offset drift error.

The control circuitry may be configured to determine an overall signal OS_{TOT} by adding together respective subtractions. In one option; the control circuitry may add the subtraction (OS1−OS3) of the output signals OS1 and OS3 to the subtraction (OS2−OS4) of the output signals OS2 and OS4 in accordance with the equation: OS_{TOT}=(OS1−OS3)+(OS2−OS4). In another option, the control circuitry may add the subtraction (OS1−OS4) of the output signals OS1 and OS4 to the subtraction (OS2−OS3) of the output signals OS2 and OS3 in accordance with the equation: OS_{TOT}=(OS1−OS4)+(OS2−OS3).

The control circuitry may comprise a microcontroller for combining the signals from each of the accelerometers. The microcontroller may perform the mathematical algorithms of all the above-described equations. Alternative, the microcontroller may only do the additions, with the subtractions being performed by instrumentation amplifiers. The output signals may be amplified prior to processing by the microcontroller, for example, the signal may be amplified by the instrumentation amplifiers. In some embodiments, the microcontroller may be located separately from the rest of the assembly, for example, in a location in which it is not subject to the temperature and vibration of drilling operations. This means that any suitable microcontroller may be used rather than ones which are not sensitive to temperature and vibration.

The accelerometers of each subassembly and the control circuitry may be mounted on a single rigid-flex printed circuit board. This provides a robust and efficient way of providing electrical signal and power connections between each subassembly and the control circuitry and avoids bad connection issues which may arise by having to connect or plug separate PCBs together at the assembly stage. In addition, the rigid-flex PCB can be folded into a compact and appropriate configuration for measuring the inclination of the measurement axes.

According to a third aspect of the present invention, there is provided a drilling tool comprising an inclinometer assembly as described above, in which each subassembly of the assembly is arranged such that the at least one sensing axis of each of its accelerometers is oriented parallel to a respective measurement axis of the drilling tool.

This arrangement allows the assembly to determining the inclination of each measurement axis of the drilling tool.

The assembly may be located in the vicinity of a drill bit attached to the tool or in the vicinity of a distal end of the drilling tool. Such an arrangement allows the assembly to determine orientation of the drill bit or distal end of the drilling tool and therefore to determine a drilling direction.

According to a fourth aspect of the present invention, there is provided a method for determining the inclination of a single measurement axis, the method comprising: providing a first pair of accelerometers comprising a first accelerometer and a second accelerometer; and providing a second pair of accelerometers comprising a third accelerometer and a fourth accelerometer; wherein each accelerometer comprises at least one sensing axis for sensing acceleration due to gravity relative to its at least one sensing axis; arranging the first and second accelerometers of the first pair such that the at least one sensing axis of each of the first and second accelerometers is orientated in the same direction as the single measurement axis and such that the second accelerometer is arranged in an orientation in which it has been rotated about its at least one sensing axis by 180 degrees relative to the first accelerometer; arranging the third and fourth accelerometers of the second pair such that the at least one sensing axis of each of the third and fourth accelerometers is orientated in the opposite direction to the at least one sensing axis of each of the first and second accelerometers and such that the fourth accelerometer is arranged in an orientation in which it has been rotated about its at least one sensing axis by 180 degrees relative to the third accelerometer; receiving an output signal from the at least one sensing axis of each accelerometer and combining the output signals from the first, second, third and fourth accelerometers to determine an inclination of the subassembly indicative of the inclination of the single measurement axis.

The method's use of four accelerometers per measurement axis, i.e. the first to fourth accelerometers described above, means that the subassembly generates four times the signal compared to a single accelerometer. This significantly improves the signal-to-noise ratio. Indeed, the signal-to-noise ratio is improved by a factor of √4 i.e. by a factor of two. Furthermore, when the signal is processed digitally, the extra signal strength adds two extra bits of resolution for a given sampling time, all other things being equal. A proportion of the noise can also be removed from the output signals from the accelerometers by using analogue or digital filtering techniques.

The use of multiple accelerometers in the arrangement described above means that errors in the signals can be reduced or corrected simply by combining the signals rather than having to use error correction algorithms. Consequently, processing of the signal is reduced and the speed of determining inclination is increased. In particular, by arranging the second and fourth accelerometers in an orientation in which they have been rotated about their at least one sensing axis by 180 degrees relative to the first and third accelerometers respectively, any misalignment or cross-talk errors present in the output signals from the second and fourth accelerometers is given a polarity opposite to that of misalignment or cross-talk errors present in the output signals from the first and third accelerometers. As a result, the signal strength can be increased and errors reduced simply by combining the signals. In addition, by arranging the at least one sensing axis of each of the third and fourth accelerometers of the second pair such that they are orientated in the opposite direction to the at least one sensing axis of each of the first and second accelerometers, any offset drift error present in the output signals from the third and fourth accelerometers is given a polarity opposite to that of offset drift errors present in the output signals from the first and second accelerometers. As a result, the signal strength can be increased and errors reduced simply by combining the signals.

Combining the output signals from the first, second, third and fourth accelerometers may comprise adding together the output signals OS1, OS2 from the first and second accelerometers respectively. Combining the output signals may further comprise adding together the output signals OS3, OS4 from the at least one sensing axes of the third and fourth accelerometers respectively. Combining signals in this way helps to reduce misalignment and cross-talk errors. By arranging the second and fourth accelerometers in an orientation in which their at least one sensing axis has been rotated by 180 degrees relative to the first and third accelerometers respectively means that any errors due to misalignment or cross-talk present in the output signals of the second and fourth accelerometers have an opposite polarity to that of errors due to misalignment or cross-talk present in the output signals of the first and third accelerometers respectively. Therefore, adding the output signal OS1 from the first accelerometer to the output signal OS2 from the second accelerometer and adding the output signal OS3 from the third accelerometer to the output signal OS4 from the fourth accelerometer results in the error signals being reduced or cancelled to significant degree due to their opposing polarities.

The method may further comprise determining an overall signal OS_{TOT} by subtracting the summation (OS3+OS4) of the output signals OS3 and OS4 from the summation (OS1+OS2) of the output signals OS1 and OS2 in accordance with the equation: OS_{TOT}=(OS1+OS2)−(OS3+OS4). Combining signals in this way means that any offset drift error present in the output signals of the accelerometers is reduced or cancelled to significant degree when the subtraction is performed.

Alternatively, pairs of output signals can be subtracted by the control circuitry prior to adding any signals together. In one option, combining the output signals from the first, second, third and fourth accelerometers may comprise subtracting the output signal OS3 of the third accelerometer from the output signal OS1 of the first accelerometer and subtracting the output signal OS4 of the fourth accelerometer from the output signal OS2 of the second accelerometer. In another option, combining the output signals from the first, second, third and fourth accelerometers may comprise subtracting the output signal OS4 of the fourth accelerometer from the output signal OS1 of the first accelerometer and subtracting the output signal OS3 of the third accelerometer from the output signal OS2 of the second accelerometer. Combining signals in this way means that any offset drift error present in the output signals of the accelerometers is reduced or cancelled to significant degree when the respective subtracting is performed.

By arranging the third and fourth accelerometers such that their at least one sensing axes are orientated in the opposite direction to the at least one sensing axes of the first and second accelerometers, the output signals OS3 and OS4 from the third and fourth accelerometers respectively have an opposite polarity to the output signals OS1 and OS2 of the first and second accelerometers. Hence, subtracting of the output signals OS3 and OS4 from the output signals OS1 and OS2 increases the signal strength to four times the signal strength of a single accelerometer whilst also reducing offset drift error.

Optionally, the method may comprise determining an overall signal OS_{TOT} by adding together respective subtractions. In one option; the subtraction (OS1−OS3) of the output signals OS1 and OS3 may be added to the subtraction (OS2−OS4) of the output signals OS2 and OS4 in accordance with the equation: OS_{TOT}=(OS1−OS3)+(OS2−OS4). In another option, the subtraction (OS1−OS4) of the output signals OS1 and OS4 may be added to the subtraction (OS2−OS3) of the output signals OS2 and OS3 in accordance with the equation: OS_{TOT}=(OS1−OS4)+(OS2−OS3).

According to a fifth aspect of the present invention, there is provided a method for determining inclination of each of three mutually orthogonal measurement axes, the method comprising performing the above-described method in respect of each measurement axis.

This method increases the total number of accelerometers used to twelve, i.e. four accelerometers for each axis. Therefore, the benefits of improved signal-to-noise ratio and error reduction described above in respect of a single measurement axis are achieved for each of the three measurement axes.

Features described in relation to one aspect may equally be applied to other aspects of the invention.

Embodiments of the invention will now be described, by way of example only, with reference to the accompanying drawings, in which:

FIG. 1 is a schematic illustration of an example accelerometer in two different orientations.

FIG. 2 is a schematic illustration of an example accelerometer having a misalignment error.

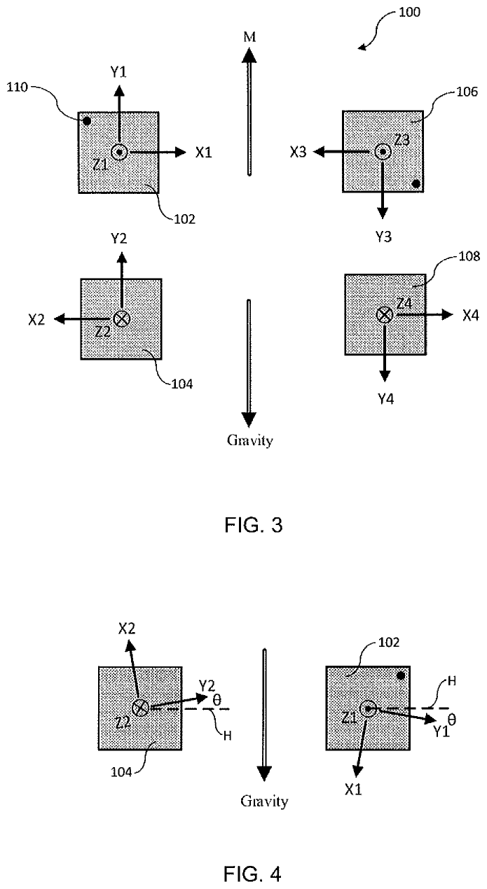

FIG. 3 is a schematic illustration of an inclinometer subassembly in accordance with an embodiment of the present invention.

FIG. 4 shows the first and second accelerometers of FIG. 3 each having a misalignment error and rotated 90 degrees clockwise.

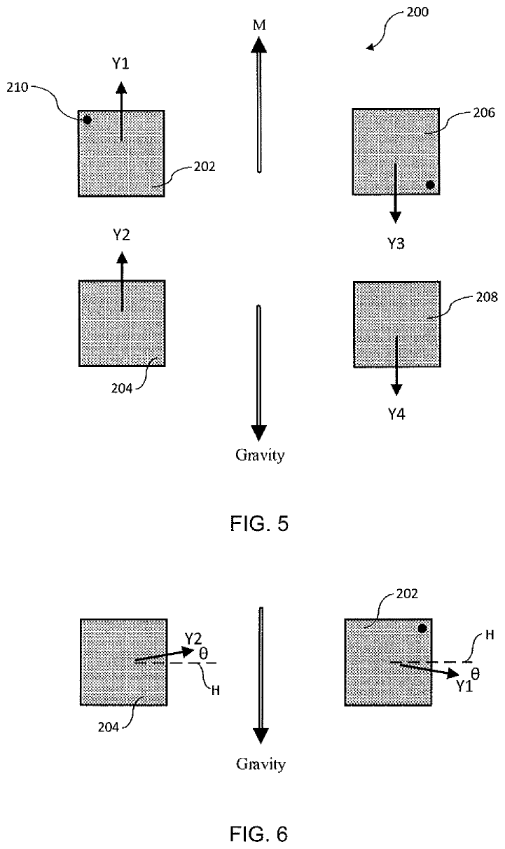

FIG. 5 is a schematic illustration of an inclinometer subassembly in accordance with another embodiment of the present invention.

FIG. 6 shows the first and second accelerometers of FIG. 5 each having a misalignment error and rotated 90 degrees clockwise.

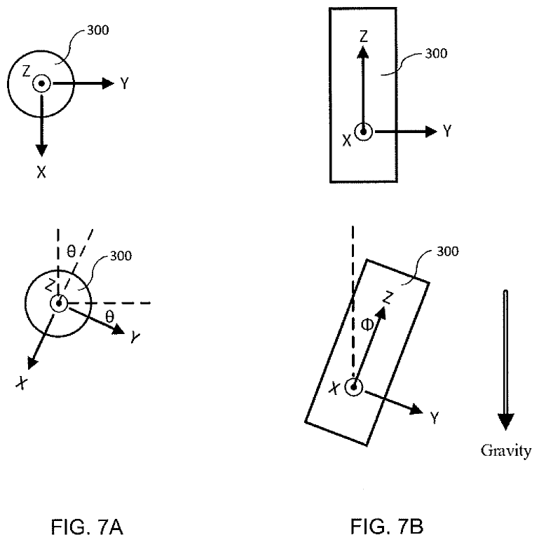

FIGS. 7A and 7B show a schematic illustration of the inclination measurement axes of a drilling tool in various orientations, which convention will be adopted in the subsequent figures. In particular, FIG. 7A is a view from the “top” side of the tool look down the tool and FIG. 7B is a view from the side of the tool.

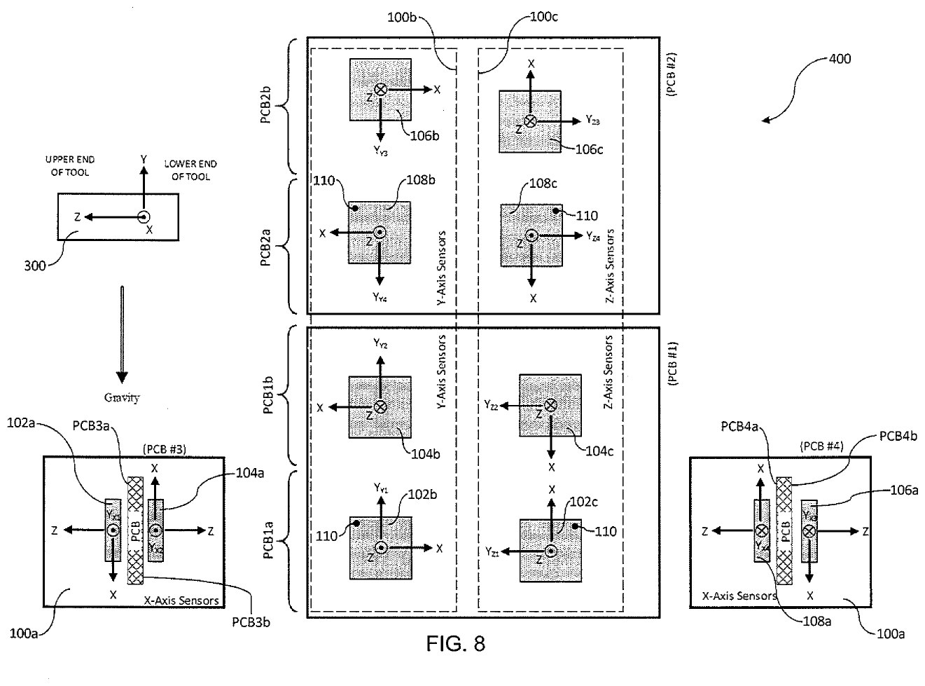

FIG. 8 is a schematic illustration of an inclinometer assembly in accordance with an embodiment of the present invention.

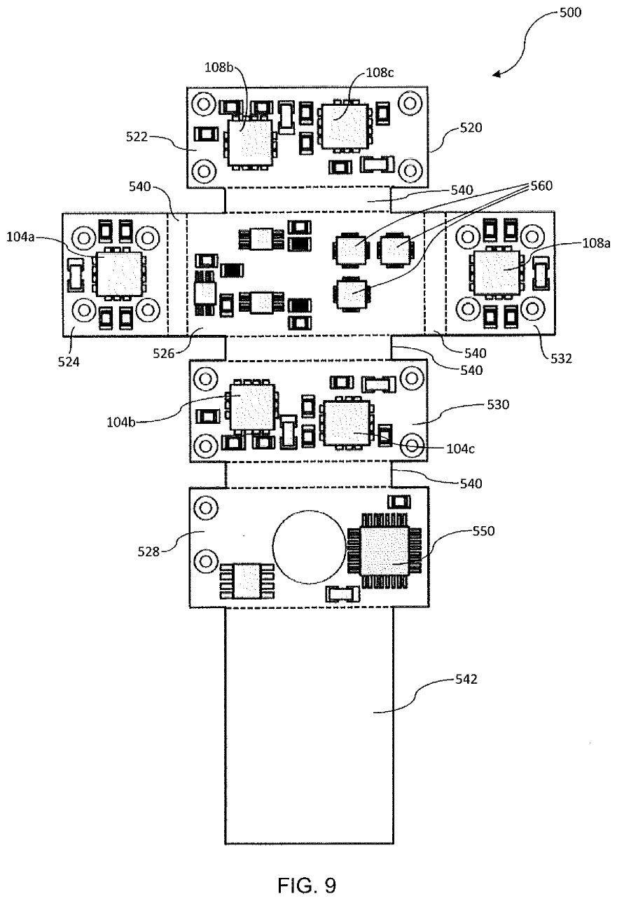

FIG. 9 is a view of one side of an inclinometer assembly in accordance with an embodiment of the present invention mounted on a rigid-flex printed circuit board.

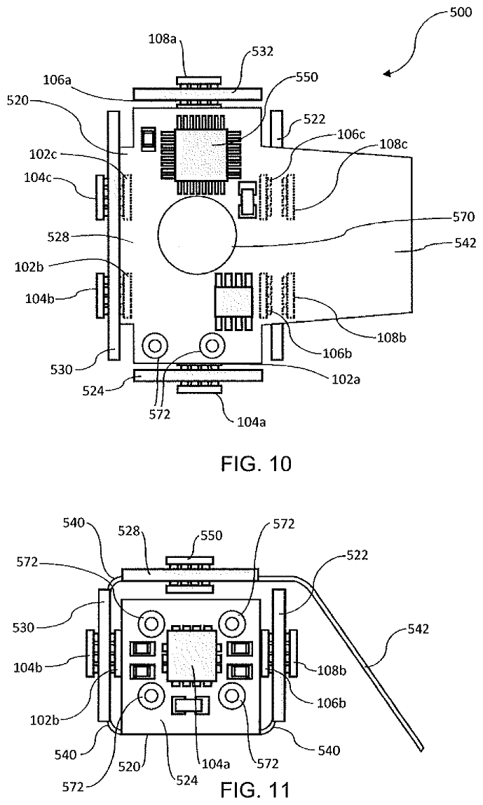

FIG. 10 is a plan view of the inclinometer assembly of FIG. 9 in which the rigid-flex printed circuit board has been folded into an installation configuration.

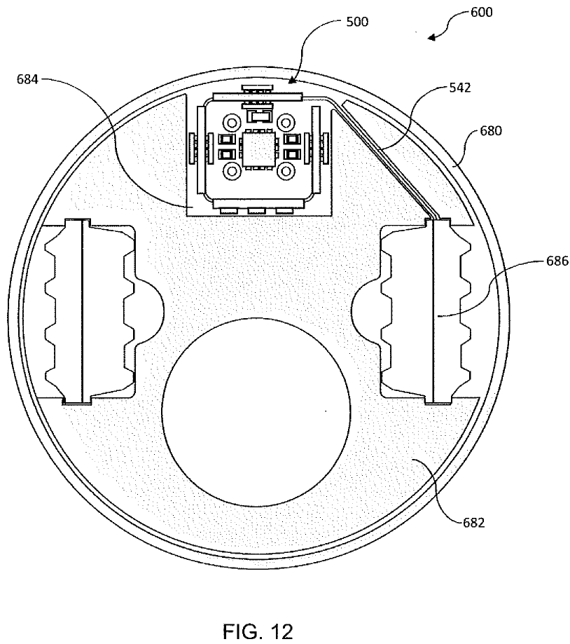

FIG. 11 is a side view of the inclinometer assembly of FIG. 10.

FIG. 12 is a cross-sectional view across the longitudinal axis of a drilling tool showing the inclinometer assembly of FIGS. 9 to 11 installed within the drilling tool.

Schematic illustrations have been included in the present document in the interests of simplifying the description of the invention. The illustrations are schematic in that they omit ancillary components which are not necessary for understanding how the invention is carried out and the orientation and positioning of the components have been chosen for clarity rather than as an example of how the components would necessarily be laid out in practice.

FIG. 3 is a schematic illustration of an inclinometer subassembly 100 in accordance with an embodiment of the present invention. The subassembly 100 comprises a first accelerometer 102, a second accelerometer 104, a third accelerometer 106 and a fourth accelerometer 108. The first 102 and second 104 accelerometers define a first pair of accelerometers and the third 106 and fourth 108 accelerometers define a second pair of accelerators.

Each of the accelerometers 102, 104, 106 and 108 has a set of three mutually orthogonal sensing axes X, Y and Z. Each sensing axis senses or measures acceleration due to gravity g relative to the sensing axis. The first accelerometer 102 produces output signals X1, Y1 and Z1, the second accelerometer 104 produces output signals X2, Y2 and Z2, the third accelerometer 106 produces output signals X3, Y3 and Z3 and the fourth accelerometer 108 produces output signals X4, Y4 and Z4. Any suitable three-axis accelerometer may be used for the accelerometers 102, 104, 106 and 108.

The Y-axis of each of the accelerometers 102, 104, 106 and 108 is arranged parallel to a measurement axis M. In this described embodiment, the Y-axis of each of the accelerometers 102, 104, 106 and 108 has been found to be more consistent and accurate than the X- and Z-axes. In particular, the offset of the Y-axis has been found to drift less at high temperatures than the X- and Z-axes. The Y-axis of each of the accelerometers 102, 104, 106 and 108 therefore defines a primary sensing axis and the X- and Z-axes define secondary axes. Only the output signals Y1, Y2, Y3 and Y4 of the Y-axis of each of the accelerometers 102, 104, 106 and 108 are used; the outputs from the X- and Z-axes are effectively being ignored or cancel each other.

However, it will be appreciated that in other accelerometers the X- or Z-axis may be the more accurate and consistent axis. In which case, either the X- or Z-axis may define the primary sensing axis.

The Y-axis of each of the first 102 and second 104 accelerometers is orientated in the same direction as the measurement axis M. The second accelerometer 104 is arranged in an orientation in which it has been rotated about its Y-axis by 180 degrees relative to the first accelerometer. In this orientation, the X-axis of each of the first 102 and second 104 accelerometers point in opposite directions and Y-axis of each of first 102 and second 104 accelerometers point in opposite directions.

In the schematic illustration of FIG. 3, the top side of the first accelerator 102 is visible (as indicated by the presence of the dot 110 in the top left-hand corner of the first accelerometer 102) and the bottom side of the second accelerometer 104 is visible. In practice, the second accelerometer 104 would not be mounted with its bottom side visible but would be placed on the opposite side of a printed circuit board from the first accelerometer 102 in order to achieve the 180 degree rotation about the Y-axis.

The Y-axis of each of the third 106 and fourth 108 accelerometers is orientated in the opposite direction to the first 102 and second 104 accelerometers. The fourth accelerometer 108 is arranged in an orientation in which it has been rotated about its Y-axis by 180 degrees relative to the third accelerometer 106. In this orientation, the X-axis of each of the third 106 and fourth 108 accelerometers point in opposite directions and Z-axis of each of third 106 and fourth 108 accelerometers point in opposite directions.

The accelerometers 102, 104, 106 and 108 are matched such that the first 102 and second 104 accelerometers have substantially the same misalignment error and the third 106 and fourth 108 accelerometers have substantially the same misalignment error. In addition, the offset drift of the first accelerometer 102 is substantially thermally matched to the offset drift of one of the third 106 and fourth 108 accelerometers and the offset drift of the second 104 accelerometer is substantially thermally matched to the offset drift of the other of the third 106 and fourth 108 accelerometers. It has been found that accelerometers from the same manufacturing batch have similar offsets and offset drifts with temperature. Furthermore, by simple experimentation, it is possible if necessary to pre-test devices and pair up devices that have similar offset drifts with temperature.

The output signals Y1, Y2, Y3 and Y4 are provided to control circuitry (not shown in FIG. 3) so that an inclination of the subassembly 100 indicative of the inclination of the measurement axis M can be determined based on a combination of the output signals Y1, Y2, Y3 and Y4 from the first 102, second 104, third 106 and fourth 108 accelerometers respectively.

The output signals Y1, Y2, Y3 and Y4 are combined by the control circuitry (not shown) by adding together the output signals Y1 and Y2 from the first 102 and second 104 accelerometers, i.e. the first pair of accelerometers, to form a first summation or combined signal (Y1+Y2). The output signals are further combined by adding together the output signals from the third 106 and fourth 108 accelerometers, i.e. the second pair of accelerometers, to form a second summation or combined signal (Y3+Y4). An overall output signal Y is then determined by subtracting the second combined signal from the first combined signal in accordance with Equation (1) below:

Y=(Y1+Y2)−(Y3+Y4) (1)

By combining the output signals Y1, Y2, Y3 and Y4 in accordance with Equation (1) above, errors due to cross-talk, misalignment and offset drift are reduced, as discussed further below. Vibration Rectification Error (VRE) is also reduced.

FIG. 4 illustrates how misalignment errors are reduced. This figure only shows the first 102 and second 104 accelerometers, i.e. the first pair of accelerometers, which have been rotated clockwise by 90 degrees for the purposes of illustration such that the Y-axes of both accelerometers 102 and 104 should be horizontal. In FIG. 4, the output signals Y1 and Y2 should ideally be zero. However, due to a misalignment error, each of accelerometers 102 and 104 has its sensing axes rotated very slightly from the ideal horizontal position H by an angle θ, which angle is exaggerated in FIG. 4 for the purposes of illustration. Consequently, the Y-axis of the first accelerometer 102 is slightly inclined below the ideal horizontal position H, whereas the Y-axis of the second accelerometer 104 is slightly inclined above the ideal horizontal position H because the second accelerometer 104 is arranged in an orientation in which it has been rotated about its Y-axis by 180 degrees relative to the first accelerometer. As a result, the output signal Y2 produces a small positive output and the output signal Y1 produces a small negative signal. As discussed above, accelerometers 102 and 104 are matched such that they have substantially the same misalignment error. Therefore, when the output signals Y1 and Y2 are summed to produce the first combined signal (Y1+Y2), the two misalignment errors cancel to a significant degree, thus reducing the effect of the misalignment error.

A reduction in the misalignment errors between the third 106 and fourth 108 accelerometers is achieved by the summation of the output signals Y3 and Y4 for the same reasons as discussed above for the first 102 and second 104 accelerometers.

Arranging the first 102 and second 104 accelerometers in a first pair and summing the output signals Y1 and Y2 also assists in reducing reduces cross-talk between the accelerometers 102 and 104. As discussed above, cross-talk arises due to a cross-sensitivity between the sensing axes of the accelerometers. For example, for each sensor, as the X-axis outputs increase, the Y-axis outputs also increase very slightly due to cross-talk. Referring again to FIG. 3, the second accelerometer 104 is arranged in an orientation in which it has been rotated about the at least one sensing axis by 180 degrees relative to the first accelerometer 102 such that the X-axis of each of accelerometers 102 and 104 are arranged in opposite directions and the Z-axis of each of accelerometers 102 and 104 are arranged in opposite directions. Therefore, as output signal X1 increases, output signal X2 decreases and the same result is achieved with the output signals Z1 and Z2. Since the first 102 and second 104 accelerometers are well matched, as they are rotated together about the Y-axis, crosstalk from the X and Z axes to the Y axes will cancel to a significant degree when the Y-axes are added together, thus reducing the effect of errors due to cross-talk. Consequently, there should be less change in the first combined signal (Y1+Y2) as the first pair of accelerometers 102 and 104 are rotated together about the Y-axis.

A reduction in cross-talk errors between the third 106 and fourth 108 accelerometers is achieved by the summation of the output signals Y3 and Y4 for the same reasons as discussed above for the first 102 and second 104 accelerometers.

The inclinometer subassembly 100 of FIG. 3 also helps reduce error due to offset drift. As can be seen in FIG. 3, the Y-axis of the first 102 and third 106 accelerometers are arranged at 180 degrees to one another, i.e. the Y-axis of the third accelerometer 106 is arranged in the opposite direction to the Y-axis of the first accelerometer 102. For the purposes of reducing offset drift error, the orientation of the X- and Z-axes of the accelerometers 102 and 106 does not matter and can be ignored. Since the first 102 and third 106 accelerometers are thermally matched, any drift in Y1 will be matched by a similar drift in Y3. Hence when the output signal Y3 is subtracted from the output signal Y1, the offset drift errors cancel to a significant degree, thus reducing the effect of the errors.

Considering the inclinometer subassembly 100 as a whole and referring back to Equation (1), the offset drift errors of the four accelerometers 102, 104, 106 and 108 will cancel to a significant degree when the second combined signal (Y3+Y4) is subtracted from the first combined signal (Y1+Y2) since the combined offset errors of (Y1+Y2) are similarly matched to the combined offset errors of (Y3+Y4). For optimum offset drift cancelation with temperature, the first accelerometer 102 is substantially thermally matched to the offset drift of one of the third 106 and fourth 108 accelerometers and the offset drift of the second 104 accelerometer is substantially thermally matched to the offset drift of the other of the third 106 and fourth 108 accelerometers.

FIG. 5 is a schematic illustration of an inclinometer subassembly 200 in accordance with another embodiment of the present invention. The subassembly 200 is similar to the subassembly 100 of FIG. 3 with the exception that the accelerometers have a single sensing axis. Since cross-talk between multiple sensing axes is not an issue in a single axis device, the main benefits of the arrangement of FIG. 5 are the cancellation of offset drift errors, alignment errors and VRE. Any cross-talk present is likely to be due to interference between devices and is expected to be negligible.

The subassembly 200 comprises a first accelerometer 202, a second accelerometer 204, a third accelerometer 206 and a fourth accelerometer 208. The first 202 and second 204 accelerometers define a first pair of accelerometers and the third 206 and fourth 208 accelerometers define a second pair of accelerators.

Each of the accelerometers 202, 204, 206 and 208 has a single sensing axis Y which senses or measures acceleration due to gravity g relative to the sensing axis Y. The first accelerometer 202 produces output signal Y1, the second accelerometer 204 produces output signals Y2, the third accelerometer 106 produces output signal Y3 and the fourth accelerometer 108 produces output signal Y4. Any suitable single axis accelerometer may be used for the accelerometers 202, 204, 206 and 208. Accelerometers in which the single sensing axis is denoted X or Z may also be used.

The sensing axis Y of each of the accelerometers 202, 204, 206 and 208 is arranged parallel to a measurement axis M. The sensing axis Y of each of the first 202 and second 204 accelerometers is orientated in the same direction as the measurement axis M. The second accelerometer 104 is arranged in an orientation in which it has been rotated about its sensing axis by 180 degrees relative to the first accelerometer.

In the schematic illustration of FIG. 5, the top side of the first accelerator 202 is visible (as indicated by the presence of the dot 210 in the top left-hand corner of the first accelerometer 202) and the bottom side of the second accelerometer 204 is visible. In practice, the second accelerometer 204 would not be mounted with its bottom side visible but would be placed on the opposite side of a printed circuit board from the first accelerometer 202 in order to achieve the 180 degree rotation about its sensing axis Y.

The sensing axis Y of each of the third 206 and fourth 208 accelerometers is orientated in the opposite direction to the first 202 and second 204 accelerometers. The fourth accelerometer 208 is arranged in an orientation in which it has been rotated about its sensing axis Y by 180 degrees relative to the third accelerometer 206.

The accelerometers 202, 204, 206 and 208 are matched such that the first 202 and second 204 accelerometers have substantially the same misalignment error and the third 206 and fourth 208 accelerometers have substantially the same misalignment error. In addition, the offset drift of the first accelerometer 202 is substantially thermally matched to the offset drift of one of the third 206 and fourth 208 accelerometers and the offset drift of the second 204 accelerometer is substantially thermally matched to the offset drift of the other of the third 206 and fourth 208 accelerometers. It has been found that accelerometers from the same manufacturing batch have similar offsets and offset drifts with temperature. Furthermore, by simple experimentation, it is possible if necessary to pre-test devices and pair up devices that have similar offset drifts with temperature.

The output signals Y1, Y2, Y3 and Y4 are provided to control circuitry (not shown in FIG. 5) so that an inclination of the subassembly 200 indicative of the inclination of the measurement axis M can be determined based on a combination of the output signals Y1, Y2, Y3 and Y4 from the first 202, second 204, third 206 and fourth 208 accelerometers respectively.

The output signals Y1, Y2, Y3 and Y4 are combined by the control circuitry (not shown) in the same way as the output signals Y1, Y2, Y3 and Y4 of subassembly 100 of FIG. 3 discussed above and in accordance with Equation (1) above. By combining the output signals Y1, Y2, Y3 and Y4 in accordance with Equation (1), errors due to misalignment and offset drift are reduced. Vibration Rectification Error (VRE) is also reduced.

FIG. 6 illustrates how misalignment errors are reduced for a pair of single axis accelerometers, i.e. the first 202 and second 204 accelerometers of FIG. 5, which is essentially the same as described above for the arrangement of FIG. 4. In FIG. 6, the accelerometers 202 and 204 have been rotated clockwise by 90 degrees from their orientation in FIG. 5 for the purposes of illustration. The sensing axes Y of both accelerometers 202 and 204 should be horizontal such that the output signals Y1 and Y2 are ideally zero. However, due to a misalignment error, each of accelerometers 202 and 204 has its sensing axes rotated very slightly from the ideal horizontal position H by an angle θ, which angle is exaggerated in FIG. 6 for the purposes of illustration. As a result, the output signal Y2 produces a small positive output and the output signal Y1 produces a small negative signal.

Since the misalignment errors of accelerometers 102 and 104 are matched, when the output signals Y1 and Y2 are summed, the two misalignment errors cancel to a significant degree, thus reducing the effect of the misalignment error.

As discussed above, in other multi-axis accelerometers a sensing axis other than the Y-axis may be the primary axis and in other single axis accelerometers the sensing axis may be denoted by an X or a Z instead of Y. Therefore, Equation (1) above can be generalised to Equation (2) below:

OS_{TOT}=(OS1+OS2)−(OS3+OS4) (2)

where OS_{TOT} is the overall output signal from the subassembly, OS1 is the output signal from the first accelerometer, OS2 is the output signal from the second accelerometer, OS3 is the output signal from the third accelerometer and OS4 is the output signal from the fourth accelerometer, (OS1+OS2) is the first summation or combined signal and (OS3+OS4) is the second summation or combined signal.

As discussed above, combining the output signals Y1, Y2, Y3 and Y4 in accordance with Equation (1) above can help to reduce VRE. In particular, the subtraction of Equation (1) can help reduce the non-linearity aspect of VRE.

Assume the output signals Y1 and Y3 from the first 102, 202 and third 106, 206 accelerometers can be described by nth order polynomials as follows (to simplify the equations, the first 102, 202 and third 106, 206 accelerometers are represented by symbols A and B and their output signals are as described below):

α_{Ao}=k_{A0}+k_{A1}α_{Ai}+k_{A2}α_{Ai}²+k_{A3}α_{Ai}³+ . . .

α_{Bo}=k_{B0}+k_{B1}α_{Bi}+k_{B2}α_{Bi}²+k_{B3}α_{Bi}³+ . . .

### Where:

α_{Ai} and α_{Bi} are input signals to sensor A and sensor B respectively;
α_{Ao} and α_{Bo} are output signals from sensor A and sensor B respectively;
k_{A0} and k_{B0} are the offsets of sensor A and sensor B respectively; and
k_{A1} and k_{B1} are the scale factors for sensor A and sensor B respectively.
k_{An} and k_{Bn} are the nth order coefficient of nonlinearity for sensor A and B respectively.
Assume input signals to sensors A and B respectively of:

α_{Ai}=S+N cos ωt

α_{Bi}=−(S+N cos ωt)

N.B. Accelerometer B is rotated 180° relative to accelerometer A.

### Then:

α_{Ao}=k_{A0}+k_{A1}(S+N cos ωt)+k_{A2}(S+N cos ωt)²+k_{A3}(S+N cos ωt)³+k_{A4}(S′N cos ωt)⁴+ . . .

And:

α_{Bo}=k_{B0}+k_{B1}(S+N cos ωt)+k_{B2}(S+N cos ωt)²+k_{B3}(S+N cos ωt)³+k_{B4}(S′N cos ωt)⁴+ . . .

If we subtract one signal from the other (ignoring the 4^{th} order terms and above in the above equations), we get:

$${α}_{Ao} - {α}_{Bo} = ( {k}_{A 0} - {k}_{B 0} ) + ( {k}_{A 1} + {k}_{B 1} ) S + ( {k}_{A 1} + {k}_{B 1} ) N cos ω t + ( {k}_{A 2} - {k}_{B 2} ) ( {S}^{2} + 2 SN cos ω t + {N}^{2} {cos}^{2} ω t ) + ( {k}_{A 3} + {k}_{B 3} ) ( {S}^{3} + 2 {S}^{2} N cos ω t + 3 {SN}^{2} {cos}^{2} ω t + {S}^{2} N cos ω t + {N}^{3} {cos}^{3} ω t ) + …$$

The time-averaged output is equal to the sum of the time-average values of all components on the right hand side of the above equation.
The odd-order cos terms average to zero, i.e.

$$\frac{{\int }_{0}^{T} {cos}^{n} ω t dt}{T} = 0 ( n = odd )$$

and the first even order terms average to:

$$\frac{{\int }_{0}^{T} {cos}^{2} ω t dt}{T} = \frac{1}{2}$$

Thus, the time-average output is:

$$\overline{{α}_{Ao} - {α}_{BO}} = ( {k}_{A 0} - {k}_{B 0} ) + ( {k}_{A 1} + {k}_{B 1} ) S + ( {k}_{A 2} - {k}_{B 2} ) ( {S}^{2} + \frac{{N}^{2}}{2} ) + ( {k}_{A 3} + {k}_{B 3} ) ( {S}^{3} + \frac{3 {SN}^{2}}{2} ) + … \qquad ( 3 )$$

Thus, it can be seen from Equation (3) that, if the accelerometers A and B (i.e. Y1 and Y3) are well matched, the offsets will cancel. All even-order non-linearity, including the offset of the 0^{th} order term, is eliminated, thereby reducing VRE. Furthermore, the subtraction does make the odd-order non-linearity any worse. In addition, the resulting output signal is doubled and one extra bit of resolution is obtained for digital processing of the signal.

One of the applications for the inclinometer subassemblies 100 and 200 of FIGS. 3 and 5 is in a drilling tool. FIGS. 7A and 7B are schematic illustrations of the measurement axes of a drilling tool 300 in various orientations. The inclination of each measurement axis of the drilling tool 300 can be determined by a separate subassembly. FIG. 7A shows a view from the “top” side of the tool 300 looking down the tool 300. In FIG. 7A, the X- and Y-axes are in the plane of the page and the Z-axis is coming out of the page. The lower drawing in FIG. 7A shows the tool 300 rotated by an angle θ about the z-axis. FIG. 7B shows a view from the side of the tool 300. In FIG. 7B, the Y- and Z-axes are in the plane of the page and the X-axis is coming out of the page. The lower drawing in FIG. 7B shows the tool 300 inclined at an angle $ to the vertical. This convention will be adopted in the subsequent figures.

FIG. 8 is a schematic illustration of an inclinometer assembly 400 in accordance with an embodiment of the present invention for determining the inclination of three mutually orthogonal measurement axes X, Y and Z of the assembly 400 which in turn correspond to the three mutually orthogonal measurement axes X, Y and Z of a drilling tool 300. The assembly 400 comprises three of the subassemblies 100 described with reference to FIG. 3, i.e. subassemblies 100a, 100b, 100c. The assembly 400 therefore comprises twelve accelerometers. One subassembly comprising four accelerometers is provided for each of the three measurement axes X, Y and Z respectively. More particularly, subassembly 100a determines the inclination of measurement axis X, subassembly 100b determines the inclination of measurement axis Y and subassembly 100c determines the inclination of measurement axis Z.

Each subassembly 100a, 100b and 100c is split across two printed circuit boards (PCBs); subassembly 100a for measurement of the tool's X-axis is split across PCBs 3 and 4, subassembly 100b (denoted by the left-hand dashed box) for measurement of the tool's Y-axis is split across PCBs 1 and 2 and subassembly 100c (denoted by the right-hand dashed box) is also split across PCBs 1 and 2. Although FIG. 8 shows the subassemblies split across multiple PCBs, the figure is schematic and, in practice, all the PCBs may be mounted on a single rigid-flex PCB as shown in FIG. 9 but with the accelerometers mounted on the rigid parts of the rigid-flex PCB to prevent alignment errors.

Each of the first 102 and second 104 accelerometers of each subassembly 100 are mounted on the same PCB and each the third 106 and fourth 108 accelerometers of each subassembly 100 are mounted on the same PCB. This is done to achieve effective cross-talk and misalignment cancellation, as discussed above. In particular, the first 102a and second 104a accelerometers of subassembly 100a are mounted on opposing sides PCB3a, PCB3b of PCB3 and the third 106a and fourth 108a accelerometers of subassembly 100a are mounted on opposing sides PCB4a, PCB4b of PCB4. The first 102b and second 104b accelerometers of subassembly 100b are mounted on opposing sides PCBla, PCB1b of PCB1 and the third 106b and fourth 108b accelerometers of subassembly 100b are mounted on opposing sides PCB2a, PCB2b of PCB2. The first 102c and second 104c accelerometers of subassembly 100c are mounted on opposing sides PCBla, PCB1b of PCB1 and the third 106c and fourth 108c accelerometers of subassembly 100c are mounted on opposing sides PCB2a, PCB2b of PCB2.

In the schematic illustration of PCBs 1 and 2 in FIG. 8, the top side of the accelerators 102b, 102c, 108b and 108c are visible (as indicated by the presence of the dot 110 in the corners of the first accelerometers) and the bottom side of the accelerometers 104b, 104c, 106b, 106c is visible. This schematic representation has been done for the purposes of clarity so that all accelerometers are visible from a single viewpoint. As discussed above, in practice, the accelerometers 104b, 104c, 106b, 106c are not mounted with their bottom side visible but are placed on the opposite side of their respective PCB printed circuit board opposite accelerators 102b, 102c, 108b and 108c respectively. This positioning helps to achieve the 180 degree rotation about their Y axes.

As discussed above with respect to FIG. 3, only the output signals of the Y-axis of each of the accelerometers 102, 104, 106 and 108 of each of the subassemblies 100 are used; the outputs from the X- and Z-axes are effectively being ignored or cancel each other. The Y-axis of each of the accelerometers 102, 104, 106 and 108 of each of the subassemblies 100 is arranged parallel to its respective measurement axis X, Y, Z.

The output signals of the Y-axis of each of the accelerometers 102a, 104a, 106a, and 108a of the subassembly 100a are Y_{X1}, Y_{X2}, Y_{X3} and Y_{X4} respectively. The output signals of the Y-axis of each of the accelerometers 102b, 104b, 106b, and 108b of the subassembly 100b are Y_{Y1}, Y_{Y2}, Y_{Y3} and Y_{Y4} respectively. The output signals of the Y-axis of each of the accelerometers 102C, 104C, 106C, and 108C of the subassembly 100C are Y_{Z1}, Y_{Z2}, Y_{Z3} and Y_{Z4} respectively.

The overall output signals X_{TOT}, Y_{TOT} and Z_{TOT} from the subassemblies 100a, 100b and 100c for the measurement axes X, Y and Z respectively are determined in accordance with the following equations:

X_{TOT}=(Y_{X1}+Y_{X2})−(Y_{X3}+Y_{X4}) (4)

Y_{TOT}=(Y_{Y1}+Y_{Y2})−(Y_{Y3}+Y_{Y4}) (5)

Z_{TOT}=(Y_{Z1}+Y_{Z2})−(Y_{Z3}+Y_{Z4}) (6)

The overall output signals X_{TOT}, Y_{TOT} and Z_{TOT} provide an indication of the inclination of the measurement axes X, Y and Z of the assembly which in turn provide an indication of the inclination of the measurement axes X, Y and Z of the drilling tool. In the orientation shown in FIG. 8, when the net acceleration acting on the drilling tool is gravity g (i.e. when the tool is stationary or with vibration filtered or averaged out), X_{TOT} and Z_{TOT} will each read 0 g because they are horizontal. The output signals Y_{Y1}, Y_{Y2}, Y_{Y3} and Y_{Y4} from the Y-axis of each of the accelerometers 102b, 104b, 106b and 108b are +1 g, +1 g, −1 g and −1 g respectively. Therefore, when these output signals are combined in accordance with Equation (5) above, Y_{TOT} will read +4 g. This is indicative of a reading of +1 g, i.e. a measurement axis arranged at 90 degrees above the horizontal, because, as discussed above, each subassembly produces an output signal which is 4 times the amplitude of a single accelerometer due to the use of four accelerometers per measurement axis. The overall output signal can be divided by four to obtain a signal within the range ±1 g. Alternatively, the 4 times amplitude signal can be used by the control circuitry and then a scale factor applied to obtain a final output signal.

The overall output signals X_{TOT}, Y_{TOT} and Z_{TOT} can then be used to determination tool deviation or inclination ϕ, which is measured from vertical. Prior to determining tool deviation ϕ, residual errors in the X_{TOT}, Y_{TOT} and Z_{TOT} output signals are compensated for by calibrating the accelerometers at various temperatures, which will correct as much of the remaining offset and sensitivity errors as possible. It will also correct for linearity errors. The final calibrated output signals from each of the subassemblies 100a, 100b and 100c are Aₓ, A_{y} and A_{z} respectively.

Tool deviation ϕ from vertical can be determined using Equation (7) below:

$$∅ = {tan}^{- 1} ( \frac{\sqrt{{A}_{x}^{2} + {A}_{y}^{2}}}{{A}_{z}} ) \qquad ( 7 )$$

The tool rotation θ, is measured with respect to a given edge along the tool's length.

FIG. 9 is shows an inclinometer assembly 500 in accordance with an embodiment of the present invention mounted on a rigid-flex PCB 520. For conciseness, only one side of the rigid-flex PCB is shown in FIG. 9. However, the PCB is populated with components on its reverse side also and the key components on the reverse side are discussed below.

The rigid-flex PCB 520 comprises rigid PCB portions 522, 524, 526, 528,530 and 532 and flexible PCB portions 540 and 542. Rigid PCB portions 524 and 532 are approximately 25 mm by 25 mm in size and rigid PCB portions 522, 526, 528 and 530 are approximately 45 mm long by 25 mm wide. The rigid PCB portions 522, 524, 526, 528,530 and 532 carry electronic components and the flexible PCB portions 540 and 542 provide electrical and mechanical interconnection of the rigid PCB portions 522, 524, 526, 528,530 and 532. The flexible PCB portions 540 and 542 allow the rigid-flex PCB to be folded into a certain configuration for use, as described in more detail below. The flexible PCB portions 540 and 542 comprise conductors to allow the sharing of electrical power and signals between the rigid PCB portions 522, 524, 526, 528,530 and 532. Flexible PCB portion 542 comprises conductors for providing power and signal connection to the complete assembly 500 and can be connected to a power controller assembly of a drilling tool.

Rigid PCB portion 522 corresponds to PCB2 of FIG. 8, rigid PCB portion 524 corresponds to PCB3 of FIG. 8, rigid PCB portion 530 corresponds to PCB1 of FIG. 8 and rigid PCB portion 532 corresponds to PCB4 of FIG. 8. The rigid PCB portions 522, 524, 530 and 532 carry the accelerometers of the subassemblies 100a, 100b and 100c described with reference to FIG. 8 above, as follows:
Rigid PCB portion 522 carries accelerometers 108b and 108c on its visible side. Accelerometers 106b and 106c (not shown) are mounted on the reverse side of rigid PCB portion 522 opposite accelerometers 108b and 108c respectively.
Rigid PCB portion 524 carries accelerometer 104a on its visible side. Accelerometer 102a (not shown) is mounted on the reverse side of rigid PCB portion 524 opposite accelerometer 104a. As rigid PCB portion 524 only carries two accelerometers it is smaller than rigid PCB portions 522 and 530 which each carry four accelerometers.
Rigid PCB portion 530 carries accelerometers 104b and 104c on its visible side. Accelerometers 102b and 102c (not shown) are mounted on the reverse side of rigid PCB portion 530 opposite accelerometers 104b and 104c respectively.
Rigid PCB portion 532 carries accelerometer 108a on its visible side. Accelerometer 106a (not shown) is mounted on the reverse side of rigid PCB portion 532 opposite accelerometer 108a. As rigid PCB portion 524 only carries two accelerometers it too is smaller than rigid PCB portions 522 and 530 which each carry four accelerometers.

Each of the accelerometers in FIG. 9 is an ADXL356B accelerometer produced by Analog Devices of Norwood, Mass., USA. However, it will be appreciated that other suitable accelerometers could be used. The ADXL356B accelerometer requires a 1.8V reference voltage and produces analogue output voltage signal which is ratiometric to the reference voltage and centred on 0.9V. Therefore, voltages below 0.9V will indication a negative acceleration and voltages above 0.9V will indicated a positive acceleration. The ADXL356B accelerometer also has an integral temperature sensor for determining the temperature of the accelerometer which is used to perform temperature compensation of the output signals.

The rigid PCB portions 526 and 528 carry the control circuitry of the assembly 500. The control circuitry comprises a microcontroller 550 mounted on rigid PCB portion 528 for controlling the various components of the assembly 500 and also for performing mathematical operations corresponding to the equations described in this document. Any suitable microcontroller may be used. In some embodiments of the present invention, particularly those which may use accelerometers which generate digital outputs, the microcontroller 550 may perform all the processing of the various output signals of the assembly 500. However, in the embodiment of FIG. 9, which uses accelerometers which generate analogue outputs, further e circuitry is used in order to improve the processing of the output signals. In particular, assembly 500 uses instrumentation amplifiers 560 mounted on rigid PCB portion 526 to perform the subtractions first and to amplify the voltage difference between the two signals being subtracted. For example, for a given subassembly 100, an instrumentation amplifier 560 subtracts the output signal Y3 of the third accelerometer 106 from the output signal Y1 of the first accelerometer 102 and subtracts the output signal Y4 of the fourth accelerometer 108 from the output signal Y2 of the second accelerometer 104 and multiplies the voltage difference by a certain voltage gain G. Therefore, for the assemblies 400 and 500 of FIGS. 8 and 9 respectively, the instrumentation amplifiers generate the following output signals:

X_{TOT13}=G×(Y_{X1}−Y_{X3})

X_{TOT24}=G×(Y_{X2}−Y_{X4})

Y_{TOT13}=G×(Y_{Y1}−Y_{Y3})

Y_{TOT24}=G×(Y_{Y2}−Y_{Y4})

Z_{TOT13}=G×(Y_{Z1}−Y_{Z3})

Z_{TOT24}=G×(Y_{Z2}−Y_{Z4})

This has two advantages: 1) it amplifies the signals and therefore increases the amplitude of the signal being digitised for processing by the microcontroller; and 2) it halves, i.e. from twelve to six, the number of analogue-to-digital converter (ADC) channels required by the microcontroller 550 to digitise the signals.

In addition, rigid PCB portion 526 has a multiplexer (not shown) which is used to multiplex each of the temperature-dependent voltages from the integral temperature sensor of each accelerometer into the ADC inputs of the microcontroller 550. These signals are used to perform temperature compensation as described above. Multiplexing means that the number of additional ADC channels required is reduced from twelve to three.

The microcontroller 550 is then used to determine the overall output signals for each of the measurement axes X, Y and Z by performing the following sums:

X_{TOT}=X_{TOT13}+X_{TOT24}=G{(Y_{X1}−Y_{X3})+(Y_{X2}−Y_{X4})} (8)

Y_{TOT}=Y_{TOT13}+Y_{TOT24}=G{(Y_{Y1}−Y_{Y3})+(Y_{Y2}−Y_{Y4})} (9)

Z_{TOT}=Z_{TOT13}+Z_{TOT24}=G{(Y_{Z1}−Y_{Z3})+(Y_{Z2}−Y_{Z4})} (10)

Therefore, the calculation of each overall output signal X_{TOT}, Y_{TOT} and Z_{TOT} results in a signal which has 4 times the amplitude of a signal from a single accelerometer is multiplied by the gain G of the instrumentation amplifiers 560. A scale factor can then be applied to obtain a signal within the range ±1 g. When the gain G is removed from the signals, it will be seen that Equations (8), (9) and (10) are mathematically equivalent to Equations (4), (5) and (6) respectively.

FIG. 9 also shows various ancillary circuit components which are required for the operation of the accelerometers and control circuitry but are not important for carrying out the invention. Such ancillary components will be detailed in the datasheet for the component selected and are therefore not discussed here.

FIG. 10 shows the assembly 500 of FIG. 9 folded into a configuration for installation in a drilling tool. The rigid-flex PCB 520 has been folded about its flexible PCB portions 540. Each flexible PCB portion 540 has been folded by 90 degrees to form a box-shaped assembly 500 measuring approximately 25 mm wide by 25 mm tall by 45 mm long. The rigid-flex PCB 520 is folded around an internal frame (not shown) which supports and orientates the rigid PCB portions 522, 524, 526, 528, 530 and 532. The rigid PCB portions 522, 524, 526, 528, 530 and 532 have small bolt holes 572 through which bolts pass to attach the rigid-flex PCB 520 to the internal frame. The Rigid PCB portions 524 and 532 form two short ends of the box and carry the accelerometers for determining the inclination of measurement axis X of the assembly 500. Rigid PCB portions 522 and 530 form two long sides of the box and each carry two accelerometers for determining the inclination of measurement axis Y of the assembly 500 and two accelerometers for determining the inclination of measurement axis Z of the assembly 500. Rigid PCB portions 528 and 526 (not shown) for the top and bottom of the box respectively and carry the control circuitry. Rigid PCB portion 528 arranged at the top of the box mounts the microcontroller 550. The flexible PCB portion 542 extends out from the box for connection of the assembly 500 to the drilling tool.

The mounting of the first 102 and second 104 accelerometers of a subassembly on opposing sides of the same PCB and the mounting of the third 106 and fourth 108 accelerometers on opposing sides of the same PCB can be clearly seen in FIG. 10. More particularly, FIG. 10 shows the mounting of the accelerometers on rigid PCB portions 522, 524, 530 and 532 as follows:
Rigid PCB portion 524 mounts first accelerometer 102a on a first side and mounts second accelerometer 104a on an opposing second side opposite accelerometer 102a.
Rigid PCB portion 532 mounts third accelerometer 106a on a first side and mounts fourth accelerometer 108a on an opposing second side opposite accelerometer 106a.
Rigid PCB portion 530 mounts first accelerometer 102b on a first side and mounts second accelerometer 104b on an opposing second side opposite accelerometer 102b. Rigid PCB portion 530 also mounts first accelerometer 102c on a first side and mounts second accelerometer 104c on an opposing second side opposite accelerometer 102c.
Rigid PCB portion 522 mounts third accelerometer 106b on a first side and mounts fourth accelerometer 108b on an opposing second side opposite accelerometer 106b.
Rigid PCB portion 530 also mounts third accelerometer 106c on a first side and mounts fourth accelerometer 108c on an opposing second side opposite accelerometer 106c.
Accelerometers 106b, 108b, 106c, 108c are shown in dotted outline as they are located under flexible PCB portion 542.

Assembly 500 comprises a large bolt hole 570 provided in rigid PCB portion 528 for bolting the assembly to a part of a drilling tool. Large bolt hole 570 defines a first attachment aperture for the assembly 500. To protect the assembly 500 when mounted in a drilling tool from the drilling environment, the assembly 500 is encased within a block of epoxy resin (not shown) or another suitable encasement. Such an encasement also assists in firmly holding the rigid PCB portions in place, thereby reducing movement due to vibration and alignment errors.

FIG. 11 is a side view of the inclinometer assembly of FIG. 10. The folded configuration of the rigid-flex PCB 520 about flexible PCB portions 540 can be clearly seen. Flexible PCB portion 542 extends downwardly at an angle from the rigid PCB portion 528. Rigid PCB portion 524 comprises four small bolt holes 572 through which bolts pass to attach the rigid-flex PCB 520 to the internal frame (not shown). Each small bolt hole 572 defines a second attachment aperture for the assembly 500. Similar small bolt holes are provided in the other rigid PCB portions as can be seen from FIG. 9.

FIG. 12 is a cross-sectional view across the longitudinal axis of a drilling tool 600 showing the inclinometer assembly 500 of FIGS. 9 to 11 installed within the drilling tool 600. The drilling tool 600 comprises an outer tubular casing 680 and an electronics chassis 682 housed within an interior of the outer tubular casing 680. The electronics chassis 682 is shaped to substantially conform to the interior shape of the outer tubular casing 680. The inclinometer assembly 500 is housed within a cavity 684 formed in the electronics chassis 682. The assembly 500 is firmly attached to the chassis 682 by means of a bolt (not shown) which passes through the large bolt hole 570 in rigid PCB portion 528 (see FIG. 10). The cavity 684 is sized to snugly fit the assembly 500 to inhibit movement of the assembly 500 relative to the drilling tool 600.

The flexible PCB portion 542 passes through a channel in the electronics chassis 682 and is connected to a power control assembly (PCA) 686 of the drilling tool 600. The conductors in the flexible PCB portion 542 allow for electrical signals and power to be passed between the PCA 686 and the assembly 500. The assembly 500 is installed near the distal end (not shown) of the drilling tool 600, in particular it is installed near the drill bit (not shown) at the distal end of the drilling tool, such that the assembly 500 can determine the inclination of the three measurement axes X, Y and Z of the drilling tool at or near the point it is drilling. The PCA 686 is connected to a proximal end of the drilling tool 600 at the surface such that electricals signals from the assembly can be communicated to the surface so that an operator can ascertain the inclination of the drilling tool 600. The electrical signals may be displayed on a graphical user interface of a data processing system to visually indicate the orientation of the drilling tool. The operator can then control the drilling tool 600 to drill in the desired direction.

1. An inclinometer subassembly for determining the inclination of a single measurement axis, the subassembly comprising:
a first pair of accelerometers comprising a first accelerometer and a second accelerometer; and
a second pair of accelerometers comprising a third accelerometer and a fourth accelerometer;
wherein each accelerometer comprises at least one sensing axis for sensing acceleration due to gravity relative to its at least one sensing axis;
wherein the first and second accelerometers of the first pair are arranged such that the at least one sensing axis of each of the first and second accelerometers is orientated in the same direction as the single measurement axis, wherein the second accelerometer is arranged in an orientation in which it has been rotated about its at least one sensing axis by 180 degrees relative to the first accelerometer;
wherein the third and fourth accelerometers of the second pair are arranged such that the at least one sensing axis of each of the third and fourth accelerometers is orientated in the opposite direction to the at least one sensing axis of each of the first and second accelerometers, wherein the fourth accelerometer is arranged in an orientation in which it has been rotated about its at least one sensing axis by 180 degrees relative to the third accelerometer;
wherein each accelerometer comprises an output for providing an output signal from its at least one sensing axis to control circuitry such that an inclination of the subassembly indicative of the inclination of the single measurement axis can be determined based on a combination of the output signals from the first, second, third and fourth accelerometers.

2. The inclinometer subassembly according to claim 1, wherein the accelerometers of each pair of accelerometers are mounted on the same printed circuit board.

3. The inclinometer subassembly according to claim 2, wherein the accelerometers of each pair of accelerometers are mounted on opposing sides of the same printed circuit board.

4. The inclinometer subassembly according to claim 1, wherein the first and second accelerometers are mounted on a first printed circuit board and the third and fourth accelerometers are mounted on a second printed circuit board.

5. The inclinometer subassembly according to claim 1, wherein the accelerometers are matched such that the first and second accelerometers have substantially the same misalignment error and the third and fourth accelerometers have substantially the same misalignment error.

6. The inclinometer subassembly according to claim 1, wherein the offset drift of the first accelerometer is substantially thermally matched to the offset drift of one of the third and fourth accelerometers and the offset drift of the second accelerometer is substantially thermally matched to the offset drift of the other of the third and fourth accelerometers.

7. The inclinometer subassembly according to claim 1, wherein the first accelerometer is located in the vicinity of one of the third and fourth accelerometers and the second accelerometer is located in the vicinity of the other of the third and fourth accelerometers.

8. The inclinometer subassembly according to claim 1, wherein the at least one sensing axis comprises a primary sensing axis, wherein each accelerometer further comprises two secondary sensing axes, the primary and two secondary sensing axes being arranged in mutually orthogonal directions such that each accelerometer is configured to sense acceleration due to gravity in three orthogonal axes.

9. The inclinometer subassembly according to claim 1, wherein the primary sensing axis comprises the Y axis of the accelerometers and the two secondary axes comprise the X and Z axes.

10. The inclinometer subassembly according to claim 9, wherein the Y axis of each of the first and second accelerometers is orientated in the same direction as the single measurement axis, wherein the X axes of the first and second accelerometers are orientated in opposing directions and wherein the Z axes of the first and second accelerometers are orientated in opposing directions, wherein the Y axis of each of the third and fourth accelerometers is orientated in the opposite direction to the first and second accelerometers, and wherein the X axes of the third and fourth accelerometers are orientated in opposing directions and wherein the Z axes of the third and fourth accelerometers are orientated in opposing directions.

11. An inclinometer assembly for determining the inclination of each of three mutually orthogonal measurement axes, the assembly comprising an inclinometer subassembly according to claim 1 for each axis of the assembly;
wherein each subassembly is arranged such that the at least one sensing axis of each of its accelerometers is oriented parallel to its respective measurement axis of the assembly.

12. The inclinometer assembly according to claim 11, further comprising control circuitry arranged to receive the output signal from each accelerometer of each subassembly and to determine the inclination of each subassembly about its respective measurement axis by combining the output signal from the first, second, third and fourth accelerometers of each subassembly.

13. The inclinometer assembly according to claim 11, wherein the control circuitry is configured to add together the output signals OS1, OS2 from the first and second accelerometers respectively and to add together the output signals OS3, OS4 from the at least one sensing axes of the third and fourth accelerometers respectively.

14. The inclinometer assembly according to claim 13, wherein the control circuitry is configured to determine an overall signal OS_{TOT} by subtracting the summation (OS3+OS4) from the summation (OS1+OS2) in accordance with the following equation:
OS_{TOT}=(OS1+OS2)−(OS3+OS4)

15. The inclinometer assembly according to claim 11, wherein the control circuitry is configured to subtract the output signal OS3 of the third accelerometer from the output signal OS1 of the first accelerometer and to subtract the output signal OS4 of the fourth accelerometer from the output signal OS2 of the second accelerometer.

16. The inclinometer assembly according to claim 11, wherein the control circuitry is configured to subtract the output signal OS4 of the fourth accelerometer from the output signal OS1 of the first accelerometer and to subtract the output signal OS3 of the third accelerometer from the output signal OS2 of the second accelerometer.

17. The inclinometer assembly according to claim 11, wherein the accelerometers of each subassembly and the control circuitry are mounted on a single rigid-flex printed circuit board.

18. A drilling tool comprising the inclinometer assembly of claim 11, wherein each subassembly of the assembly is arranged such that the at least one sensing axis of each of its accelerometers is oriented parallel to a respective measurement axis of the drilling tool.

19. The drilling tool according to claim 18, wherein the assembly is located in the vicinity of a drill bit attached to the tool or in the vicinity of a distal end of the drilling tool.

20. A method for determining the inclination of a single measurement axis, the method comprising:
providing a first pair of accelerometers comprising a first accelerometer and a second accelerometer; and
providing a second pair of accelerometers comprising a third accelerometer and a fourth accelerometer;
wherein each accelerometer comprises at least one sensing axis for sensing acceleration due to gravity relative to its at least one sensing axis;
arranging the first and second accelerometers of the first pair such that the at least one sensing axis of each of the first and second accelerometers is orientated in the same direction as the single measurement axis and such that the second accelerometer is arranged in an orientation in which it has been rotated about its at least one sensing axis by 180 degrees relative to the first accelerometer;
arranging the third and fourth accelerometers of the second pair such that the at least one sensing axis of each of the third and fourth accelerometers is orientated in the opposite direction to the at least one sensing axis of each of the first and second accelerometers and such that the fourth accelerometer is arranged in an orientation in which it has been rotated about its at least one sensing axis by 180 degrees relative to the third accelerometer;
receiving an output signal from the at least one sensing axis of each accelerometer and combining the output signals from the first, second, third and fourth accelerometers to determine an inclination of the subassembly indicative of the inclination of the single measurement axis.

21. The method according to claim 20, wherein combining the output signals from the first, second, third and fourth accelerometers comprises adding together the output signals OS1, OS2 from the first and second accelerometers respectively and adding together the output signals OS3, OS4 from the at least one sensing axes of the third and fourth accelerometers respectively.

22. The method according to claim 21, further comprising determining an overall signal OS_{TOT} by subtracting the summation (OS3+OS4) from the summation (OS1+OS2) in accordance with the following equation:
OS_{TOT}=(OS1+OS2)−(OS3+OS4)

23. The method according to claim 20, wherein combining the output signals from the first, second, third and fourth accelerometers comprises subtracting the output signal OS3 of the third accelerometer from the output signal OS1 of the first accelerometer and subtracting the output signal OS4 of the fourth accelerometer from the output signal OS2 of the second accelerometer.

24. The method according to claim 20, wherein combining the output signals from the first, second, third and fourth accelerometers comprises subtracting the output signal OS4 of the fourth accelerometer from the output signal OS1 of the first accelerometer and subtracting the output signal OS3 of the third accelerometer from the output signal OS2 of the second accelerometer.

25. A method for determining inclination of each of three mutually orthogonal measurement axes, the method comprising performing the method of claim 18 in respect of each measurement axis.
